(19) United States
(12) Patent Application Publication
(10) Pub. No.: US 2013/0232178 A1
(43) Pub. Date: Sep. 5, 2013

(54) CONNECTING STORYBOARD SYSTEM TO EDITORIAL SYSTEM

(71) Applicants: SONY CORPORATION, Tokyo (JP); SONY PICTURES TECHNOLOGIES, INC., Culver City, CA (US)

(72) Inventor: Yiotis Katsambas, Encino, CA (US)

(73) Assignees: SONY PICTURES TECHNOLOGIES, INC., Culver City, CA (US); SONY CORPORATION, Tokyo (JP)

(21) Appl. No.: 13/769,176

(22) Filed: Feb. 15, 2013

Related U.S. Application Data
(60) Provisional application No. 61/605,512, filed on Mar. 1, 2012.

(51) Int. Cl. G06F 17/30

(52) U.S. Cl. CPC G06F 17/30091
USPC 707/825

(57) ABSTRACT

Managing assets in a movie during production, including: storing new material in a file in a first folder in a data storage system; sending the new material to an editorial system; storing the new material in a file in a second folder in the data storage system; and creating an empty file in a third folder, wherein the empty file has the same name as the file for the new material in the first folder. Keywords include storyboard and editorial.

### CROSS-REFERENCE TO RELATED APPLICATIONS

This application claims the benefit of priority under 35 U.S.C. §119(e) of co-pending U.S. Provisional Patent Application No. 61/605,512, filed Mar. 1, 2012, entitled “Connecting a Storyboard System to an Editorial System.” The disclosure of the above-referenced application is incorporated herein by reference.

### BACKGROUND

1. Field of the Invention

The present invention relates to asset management, and more specifically, to connecting a storyboard system to an editorial system in content production.

2. Background

In the process of making a movie, a storyboard is a pre-production process that is used to visualize scenes in detail. The storyboard expresses an image to be delivered as an illustration according to a sequence, illustrates a motion of camera and/or subject for each scene by visualizing the image to be presented to an audience and a customer. For example, the storyboarding process involves many panels of images drawn by a story artist, and presented in order for the purpose of visualizing sections of a motion picture prior to production. Typically, a completed storyboard includes the information that all staff, such as a producer, a director, and an art director may use to understand how to construct the corresponding story.

### SUMMARY

The present invention provides for managing assets by connecting a storyboard system to an editorial system in content production.

In one implementation, a method of managing assets during production of a movie is disclosed. The method includes: storing new material in a file in a first folder in a data storage system; sending the new material to an editorial system; storing the new material in a file in a second folder in the data storage system; and creating an empty file in a third folder, wherein the empty file has the same name as the file for the new material in the first folder.

In another implementation, a system for managing assets is disclosed. The system includes: a data storage system configured into at least first, second, and third folders, the first folder configured to store new material in a file; a processor configured to: move the new material to a file in the second folder after the new material is sent to an editorial system; and create an empty file in the third folder, wherein the empty file has the same name as the file for the new material in the first folder.

In yet another implementation, a non-transitory storage medium storing a computer program to manage assets during production of a movie is disclosed. The computer program includes executable instructions that cause a computer to: store new material in a file in a first folder in a data storage system; send the new material to an editorial system; store the new material in a file in a second folder in the data storage system; and create an empty file in a third folder, wherein the empty file has the same name as the file for the new material in the first folder.

Other features and advantages of the present invention will become more readily apparent to those of ordinary skill in the art after reviewing the following detailed description and accompanying drawings.

### BRIEF DESCRIPTION OF THE DRAWINGS

FIG. 1 is a flowchart illustrating an asset management process in accordance with one implementation of the present invention.

FIG. 2A is a functional block diagram of an asset management system in accordance with one implementation of the present invention.

FIG. 2B is a functional block diagram of an asset management system in accordance with another implementation of the present invention.

FIG. 3A illustrates a representation of a computer system and a user.

FIG. 3B is a functional block diagram illustrating the computer system hosting the asset management process.

### DETAILED DESCRIPTION

Certain implementations as disclosed herein provide a technique for connecting a storyboard system to an editorial system in content production. In one implementation, the connection is made as a non-disruptive link. In another implementation, multiple folders are used to manage the flow of files with an editing system. After reading this description it will become apparent how to implement the invention in various implementations and applications. Although various implementations of the present invention will be described herein, it is understood that these implementations are presented by way of example only, and not limitation. As such, this detailed description of various implementations should not be construed to limit the scope or breadth of the present invention.

One of the problems historically of connecting a storyboard system to an editorial system is identifying out of all shots which ones have been updated so that the editorial system and the editor can be provided with a complete list of all the updated shots. Another problem is identifying for the storyboard artist how the sequence of images has been updated by the editorial system.

In one implementation, a new system connects an application which contains a collection of storyboards to an editorial system. As changes occur in the storyboard system, at different intervals, updates are sent to the editorial system. The system may automatically identify newly-generated shots (including updated and/or added shots) that have not been sent to the editorial system, even when multiple iterations of a sequence of shots are concurrently sent to the editing application. In particular, the new system may use three folders, for example, A, B, and C. Any new material is generated and stored in folder A. Once the material is imported to the editorial system, the material is moved to folder B and an empty file is created in folder C. The name of the empty file matches the original name of the file as it was created in folder A. Thus, it acts as a record that the file has been published. The new system can at any time identify and indicate to the users all the newly-made shots that are yet to be imported to editorial by comparing the contents of Folder A to the content of Folder C.

Accordingly, in one implementation, when an updated sequence of shots is published to editorial, the system will go through the entire list of files contained in folders A and C. It will identify any shots that have already been prepared for the editorial system, and any shots that have not already been imported to the editorial system. It will therefore ignore those identified shots and only generate editorial assets for any shots that are new. When the editor is ready to import any new material in the editing application, the system will move all the files from folder A into folder B, and create an empty file matching the same name in folder C. At the same time, it will create a source folder in the editing application that will only indicate the new material. It will also include any metadata that was sent along with the new material, wherein the metadata describes various attributes of the new material. If for any reason it is required to re-generate any material, the user could remove the corresponding empty file from folder C and republish the sequence.

The significance of having folder B is that those files that have been imported can be renamed or moved to a new location by the editor without having an impact on the applications workflow. If that is not a concern for a specific project, the creation of folder C is redundant and a variation of the new system could use folder B instead. During the creation of the source folder in the editing application, some additional metadata can be generated, including a unique keycode for each frame of the shot published, and other attributes such as dialogue for that shot, the mark in and out point of that shot, the artist that created the shot, as camera lens information, camera identifier, environment information, and/or comments.

When an edit from the editorial publish is sent back to the editing application, the edit is updated in the publication to reflect that same edit. This is accomplished with the use of two files generated by the editorial system. The first file is a movie file of the edit. The second file is a file that includes a breakdown of each shot contained in the movie (i.e., a cutlist). The system extracts the audio from the movie, as well as each frame as an image. Concurrently, the system parses the cutlist and identifies any shots that already exist in the edit. This is accomplished by searching for unique identifiers of the shots. Any shots that are not identified are created as new shots by importing the relevant images exported out of the movie. The system searches for unique identifiers on the imported material, and associates those identifiers to the newly-generated shots to avoid duplication in future imports. Once all the shots exist, a new edit is created which reflects the editorial edit and includes an audio track, with the audio that was extracted by the editorial system.

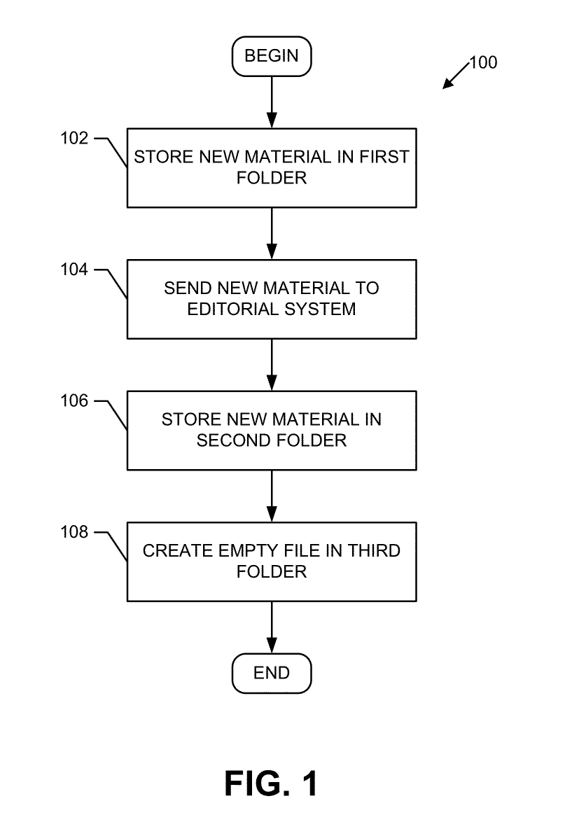

FIG. 1 is a flowchart illustrating an asset management process 100 in accordance with one implementation of the present invention. Although the asset management process 100, in the illustrated implementation, is used to manage, develop and/or analyze a story in motion picture, this technique can be modified to be used to develop and/or analyze a story in other areas, such as in computer games, commercials, TV shows, music videos, theme park rides, and in forensic visualization.

In the illustrated implementation of FIG. 1, the asset management process 100 includes storing new material in a file in a first folder of a data storage system, at box 102. In one implementation, the new material is an updated sequence of shots. The new material is then sent, at box 104, to an editorial system, and is stored in a second folder, at box 106. As discussed above, the system searches through the entire list of files contained in the first and third folders once the updated sequence of shots is published to the editorial system. It identifies any shots that have already been prepared for editorial, and any shots that have not already been imported to editorial. It ignores those identified shots and only generates editorial assets for any shots that are new. When the editor is ready to import any new material in the editing application, the system moves all the files from the first folder into the second folder (see box 106), and create an empty file matching the same name in the third folder (see box 108). Thus, an empty file is created in a third folder, at box 108, wherein this empty file has the same name as the file for the new material in the first folder. Accordingly, the creation of an empty file in the third folder acts as a record that the file has been published.

Concurrently with the creation of the empty file in the third folder, a source folder is created in the editing application that will only indicate the new material. The source folder also includes any metadata that was sent along with the material such that if the material needs to be regenerated, the user can remove the corresponding empty file from the third folder and republish the sequence.

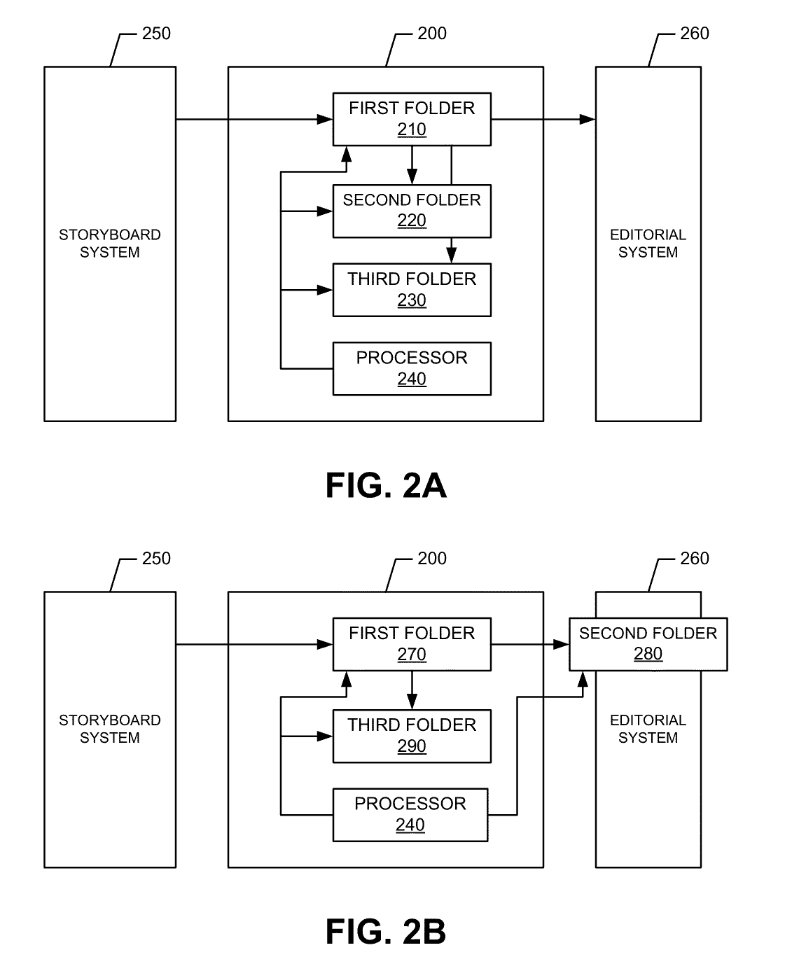

FIG. 2A is a functional block diagram of an asset management system 200 in accordance with one implementation of the present invention. In the illustrated implementation, the asset management system 200 includes three folders 210, 220, 230 and a processor 240, which controls the management of files in the three folders.

In one implementation, the system 200 connects a storyboard system 250 which contains a collection of storyboards to an editorial system 260. As changes occur in the storyboard system 250, updates are sent to the editorial system 260 at different intervals. The processor 240 in the system 200 automatically identifies newly-generated shots (including updated and/or added shots) that have not been sent to the editorial system 260, even when multiple iterations of a sequence of shots are concurrently sent to the editing application. For example, the processor 240 uses three folders 210, 220, 230. That is, the processor 240 receives and places any new material generated by the storyboard system 250 in the first folder 210. Once the material is imported to the editorial system 260, the processor 240 moves the material to the second folder 220 and creates an empty file in the third folder 230. The processor 240 matches the name of the empty file in the third folder to the original name of the file as it was created in the first folder 210. Thus, it acts as a record that the file has been published.

When the updated sequence of shots is published to the editorial system 260, the processor 240 searches through the entire list of files contained in the first and third folders 210, 230. The processor 240 identifies and ignores any shots that have already been prepared for, and any shots that have not already been imported to the editorial system 260. The processor 240 only generates editorial assets for any shots that are new. When the editor is ready to import any new material in the editing application, the processor 240 moves all the files from the first folder 210 into the second folder 220, and creates an empty file matching the same name in the third folder 230. At the same time, a source folder is created in the editing application that only indicates the new material. It also includes any metadata that was sent along with the material. If for any reason it is required to re-generate any material, the user removes the corresponding empty file from the third folder 230 and republishes the sequence. The significance of having the second folder 220 is that those files that have been imported can be renamed, or moved to a new location by the editor without having an impact on the applications workflow.

FIG. 2B is a functional block diagram of an asset management system 200 in accordance with an alternative implementation of the present invention. In the illustrated implementation of FIG. 2B, the asset management system 200 includes two folders 270, 290 and a processor 240. The second folder 280 is configured to be situated within the editorial system 260. The processor 240 controls the management of files in the two folders 270, 290 and the second folder 280 located in the editorial system 260.

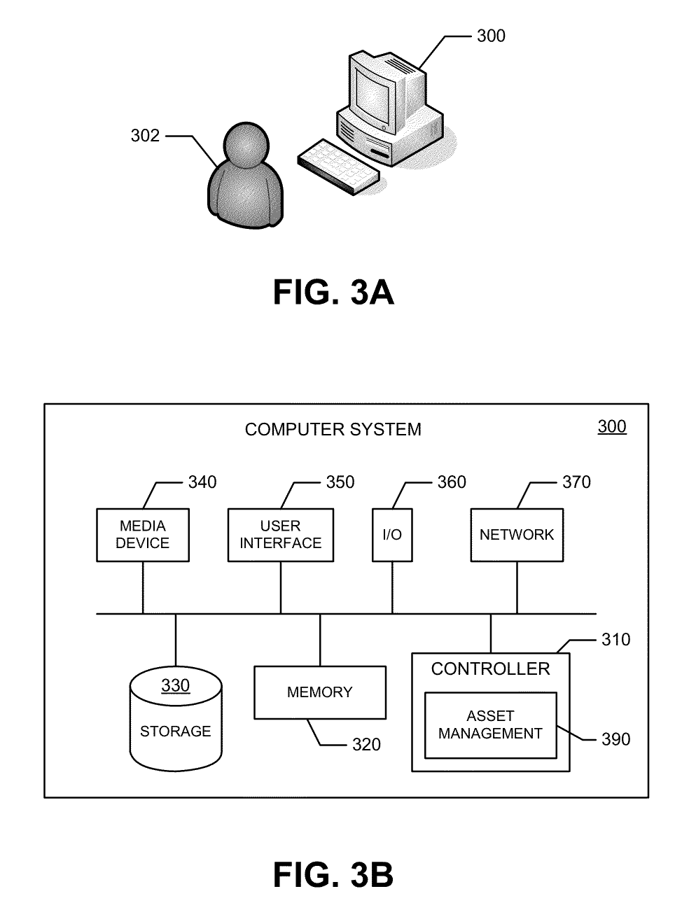

FIG. 3A illustrates a representation of a computer system 300 and a user 302. The user 302 uses the computer system 300 to perform various operations described with respect to FIGS. 1 and 2. Thus, the computer system 300 includes an asset management process 390 which is similar to the process 100 described in FIG. 1.

FIG. 3B is a functional block diagram illustrating the computer system 300 hosting the asset management process 390. The controller 310 is a programmable processor and controls the operation of the computer system 300 and its components. The controller 310 loads instructions (e.g., in the form of a computer program) from the memory 320 or an embedded controller memory (not shown) and executes these instructions to control the system. In its execution, the controller 310 provides the asset management process 390 as a software system. Alternatively, this service can be implemented as separate hardware components in the controller 310 or the computer system 300.

Memory 320 stores data temporarily for use by the other components of the computer system 300. In one implementation, memory 320 is implemented as RAM. In one implementation, memory 320 also includes long-term or permanent memory, such as flash memory and/or ROM.

Non-transitory storage 330 stores data for use by other components of the computer system 300, such as for storing data used by the asset management process 390. In one implementation, storage 330 is a hard disk drive.

The media device 340 receives removable media and reads and/or writes data to the inserted media. In one implementation, for example, the media device 340 is an optical disc drive.

The user interface 350 includes components for accepting user input from the user 302 and presenting information to the user 302. In one implementation, the user interface 350 includes a keyboard, a mouse, audio speakers, and a display. The controller 310 uses input from the user 302 to adjust the operation of the computer system 300.

The I/O interface 360 includes one or more I/O ports to connect to corresponding I/O devices, such as external storage or supplemental devices (e.g., a printer or a PDA). In one implementation, the ports of the I/O interface 360 include ports such as: USB ports, PCMCIA ports, serial ports, and/or parallel ports. In another implementation, the I/O interface 360 includes a wireless interface for communication with external devices wirelessly.

The network interface 370 includes a wired and/or wireless network connection, such as an RJ-45 or “Wi-Fi” interface (including, but not limited to 802.11) supporting an Ethernet connection.

The computer system 300 includes additional hardware and software typical of computer systems (e.g., power, cooling, operating system), though these components are not specifically shown in FIG. 3B for simplicity. In other implementations, different configurations of the computer system can be used (e.g., different bus or storage configurations or a multi-processor configuration).

The above description of the disclosed implementations is provided to enable any person skilled in the art to make or use the invention. Various modifications to these implementations will be readily apparent to those skilled in the art, and the generic principles described herein can be applied to other implementations without departing from the spirit or scope of the invention. Accordingly, additional implementations and variations are also within the scope of the invention. For example, the system can be applied to content other than movies or television, such as game software. Further, it is to be understood that the description and drawings presented herein are representative of the subject matter which is broadly contemplated by the present invention. It is further understood that the scope of the present invention fully encompasses other implementations that may become obvious to those skilled in the art and that the scope of the present invention is accordingly limited by nothing other than the appended claims.

1. A method of managing assets in a movie during production, comprising:
storing new material in a file in a first folder of a data storage system;
sending the new material to an editorial system;
storing the new material in a file in a second folder of the data storage system; and
creating an empty file in a third folder of the data storage system,
wherein the empty file has the same name as the file for the new material in the first folder.

2. The method of claim 1, further comprising
receiving the new material from a storyboard of the movie.

3. The method of claim 2, wherein the new material comprises an updated sequence of shots of the storyboard.

4. The method of claim 3, wherein sending the new material to the editorial system comprises
publishing the updated sequence of shots to the editorial system.

5. The method of claim 1, further comprising
creating a source folder in an editing application to indicate the new material.

6. The method of claim 5, wherein the source folder comprises
metadata that was sent along with the new material,
wherein the metadata describes various attributes of the new material.

7. The method of claim 6, further comprising
using the metadata to identify and delete the empty file in the third folder and republish the sequence of shots when re-generation is required.

8. The method of claim 1, further comprising
updating an edit from the editorial system.

9. The method of claim 8, further comprising
using first and second files generated by the editorial system to update the edit,
wherein the first file is a movie file of the edit and the second file is a cutlist that includes a breakdown of each shot contained in the movie.

10. The method of claim 9, further comprising
parsing the cutlist and identifying any shots that already exist in the edit by searching for unique identifiers of the shots.

11. An asset management system, comprising:
a data storage system configured into at least first, second, and third folders, the first folder configured to store new material in a file;
a processor configured to: move the new material to a file in the second folder after the new material is sent to an editorial system; and create an empty file in the third folder,
wherein the empty file has the same name as the file for the new material in the first folder.

12. The asset management system of claim 11, wherein the new material comprises an updated sequence of shots of a storyboard.

13. A non-transitory storage medium storing a computer program to manage assets during production of a movie, the computer program comprising executable instructions that cause a computer to:
store new material in a file in a first folder in a data storage system;
send the new material to an editorial system;
store the new material in a file in a second folder in the data storage system; and
create an empty file in a third folder,
wherein the empty file has the same name as the file for the new material in the first folder.

14. The non-transitory storage medium of claim 13, further comprising executable instructions that cause a computer to
receive the new material from a storyboard,
wherein the new material comprises an updated sequence of shots of the storyboard.

15. The non-transitory storage medium of claim 14, wherein executable instructions that cause a computer to send the new material to the editorial system comprises executable instructions that cause a computer to
publish the updated sequence of shots to the editorial system.

16. The non-transitory storage medium of claim 13, further comprising executable instructions that cause a computer to
create a source folder in an editing application to indicate the new material,
wherein the source folder includes metadata that was sent along with the new material, and
wherein the metadata describes various attributes of the new material.

17. The non-transitory storage medium of claim 16, further comprising executable instructions that cause a computer to
use the metadata to identify and delete the empty file in the third folder and republish the sequence of shots when re-generation is required.

18. The non-transitory storage medium of claim 13, further comprising executable instructions that cause a computer to
update an edit from the editorial system.

19. The non-transitory storage medium of claim 18, further comprising executable instructions that cause a computer to
use first and second files generated by the editorial system to update the edit,
wherein the first file is a movie file of the edit and the second file is a cutlist that includes a breakdown of each shot contained in the movie.

20. The non-transitory storage medium of claim 19, further comprising executable instructions that cause a computer to
parse the cutlist and identify any shots that already exist in the edit by searching for unique identifiers of the shots.
